(19) United States
(12) Patent Application Publication
(10) Pub. No.: US 2026/0276440 A1
(43) Pub. Date: Sep. 17, 2026

(54) METROLOGY STRUCTURES WITH A DIFFRACTION GRATING

(71) Applicant: GlobalFoundries U.S. Inc., Malta, NY (US)

(72) Inventor: Aneesh Dash, Bangalore (IN)

(21) Appl. No.: 19/077,232

(22) Filed: Mar. 12, 2025

(51) Int. Cl. G01J 1/04; G02B 6/34

(52) U.S. Cl. CPC G01J 1/0407; G02B 6/34

(57) ABSTRACT

Metrology structures and methods of forming metrology structures. The metrology structure comprises a target layer, a waveguide core including a diffraction grating, and a reflector. The target layer may include a portion that is arranged between the diffraction grating and the reflector or, alternatively, the reflector may be arranged between the diffraction grating and the portion of the target layer.

### BACKGROUND

The disclosure relates to photonic chips and, more specifically, to metrology structures and methods of forming metrology structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

Thin films may be used to construct photonic components and waveguide cores connecting photonic components. The thickness and refractive index of a thin film may either be monitored inline using external interferometry measurements on reflective surfaces or monitored by using ellipsometry measurements on a blanket wafer. External interferometry and ellipsometry, which are performed off-wafer, may suffer from focusing problems during measurements. Measurements by external interferometry and ellipsometry may also require complex curve-fitting techniques to extract the thickness and refractive index from the raw data.

Improved metrology structures and methods of forming metrology structures are needed.

### SUMMARY

In an embodiment of the invention, a metrology structure comprises a target layer, a waveguide core including a diffraction grating, and a reflector. The target layer includes a portion that may be arranged between the diffraction grating and the reflector or, alternatively, the reflector may be arranged between the diffraction grating and the portion of the target layer.

In an embodiment of the invention, a method of forming a metrology structure is provided. The method comprises forming a waveguide core including a diffraction grating, forming a target layer, and forming a reflector. The target layer includes a portion that may be arranged between the diffraction grating and the reflector or, alternatively, the reflector may be arranged between the diffraction grating and the portion of the target layer.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a cross-sectional view of a structure in accordance with embodiments of the invention.

FIG. 2 is a cross-sectional view of a structure in accordance with alternative embodiments of the invention.

FIG. 3 is a cross-sectional view of a structure in accordance with alternative embodiments of the invention.

FIG. 4 is a cross-sectional view of a structure in accordance with alternative embodiments of the invention.

FIG. 5 is a cross-sectional view of a structure in accordance with alternative embodiments of the invention.

FIG. 6 is a cross-sectional view of a structure in accordance with alternative embodiments of the invention.

FIG. 7 is a cross-sectional view of a structure in accordance with alternative embodiments of the invention.

FIG. 8 is a top view of a structure in accordance with alternative embodiments of the invention.

### DETAILED DESCRIPTION

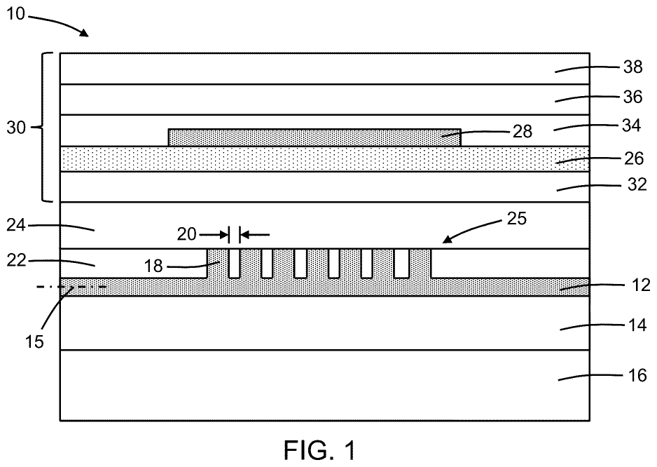

With reference to FIG. 1 and in accordance with embodiments of the invention, a structure 10 includes a waveguide core 12 that is disposed on, and overlies, a dielectric layer 14 and a semiconductor substrate 16 of, for example, a photonics chip. In an embodiment, the dielectric layer 14 may be comprised of a dielectric material, such as an oxide like silicon dioxide, and the semiconductor substrate 16 may be comprised of a semiconductor material, such as single-crystal silicon. In an embodiment, the dielectric layer 14 may be a buried oxide layer of a silicon-on-insulator substrate.

In an embodiment, the waveguide core 12 may be comprised of a material having a refractive index that is greater than the refractive index of silicon dioxide. In an embodiment, the waveguide core 12 may be comprised of a semiconductor material, such as silicon or germanium. In an embodiment, the waveguide core 12 may be formed by depositing a layer comprised of its constituent material and patterning the deposited layer with lithography and etching processes. The waveguide core 12 may extend lengthwise along a longitudinal axis 15.

The waveguide core 12 includes a diffraction grating 25 having multiple grating lines or grating segments 18 arranged with a spaced arrangement along the longitudinal axis 15. The diffraction grating 25 is characterized by parameters, such as the period of the grating segments 18, that determine the outbound angle of diffraction for light that is diffracted by the diffraction grating 25. In an embodiment, the pitch and duty cycle of the grating segments 18 may be uniform to define a periodic arrangement. In alternative embodiments, the pitch and/or the duty cycle of the grating segments 18 may be apodized (i.e., non-uniform) to define a non-periodic arrangement. The portion of the waveguide core 12 connecting the grating segments 18 may be straight or, alternative, tapered. In alternative embodiments, the diffraction grating 25 may have a different construction, such as a two-dimensional construction.

A dielectric layer 22 may be formed that overlies the waveguide core 12. The dielectric layer 22 may be comprised of a dielectric material, such as a silicon oxide (e.g., silicon dioxide), having a refractive index that is less than the refractive index of the material constituting the waveguide core 12. The refractive index of the dielectric material constituting the dielectric layer 22 may be dependent upon the deposition technique. The dielectric layer 22 may be deposited and planarized. Portions of the dielectric material of the dielectric layer 22 fill the grooves 20 between the grating segments 18 of the diffraction grating 25.

A dielectric layer 24 may be formed that overlies the dielectric layer 22. The dielectric layer 24 may be comprised of a dielectric material, such as a silicon oxide (e.g., silicon dioxide), having a refractive index that is less than the refractive index of the material constituting the waveguide core 12. The refractive index of the dielectric material constituting the dielectric layer 24 may be dependent upon the deposition technique.

A back-end-of-line stack 30 may be formed that includes a dielectric layer 32, a dielectric layer 34, a dielectric layer 36, and a dielectric layer 38. The dielectric layers 32, 34, 36, 38 of the back-end-of-line stack 30 may be comprised of dielectric materials, such as a silicon oxide (e.g., silicon dioxide) or silicon nitride. The dielectric layer 32 of the back-end-of-line stack 30 overlies the dielectric layer 24. The refractive index of the dielectric materials constituting the dielectric layers 32, 34, 36, 38 may differ.

The metrology structure embodied in the structure 10 includes a target layer 26 that may be arranged on the dielectric layer 32. The target layer 26 provides a target film for which thickness and refractive index may be measured using the diffraction grating 25. The target layer 26 may be comprised of a material, such as silicon nitride, that may be used to construct photonic components of a photonic integrated circuit. The dielectric layer 24 and the dielectric layer 32 are arranged between the diffraction grating 25 and the target layer 26. A portion of the target layer 26 is arranged to overlie and overlap with the diffraction grating 25 included in the waveguide core 12.

The metrology structure embodied in the structure 10 includes a reflector 28 that overlies a portion of the target layer 26. The reflector 28 may be a patterned layer that is comprised of a metal, such as copper or aluminum. The portion of the target layer 26 is positioned in a vertical direction between the reflector 28 and the diffraction grating 25 included in the waveguide core 12. The reflector 28 is arranged between the dielectric layers 32, 36, 38 and the portion of the target layer 26.

In use, light propagating in the waveguide core 12 along the longitudinal axis 15 encounters the diffraction grating 25 of the metrology structure. A diffracted portion of the light is diffracted by the diffraction grating 25 upwardly toward a portion of the target layer 26 and the reflector 28. A non-diffracted portion of the light, which is not diffracted by the diffraction grating 25, continues to propagate along the longitudinal axis 15 of the waveguide core 12. The target layer 26 is transparent at the wavelength of the light used in the metrology structure. The diffracted portion of the light passes through a portion of the target layer 26 and is reflected by the reflector 28 back toward the diffraction grating 25. The angle of diffraction, which is established by period of the diffraction grating 25, determines the path travelled by the diffracted light through the portion of the target layer 26. The diffracted light that travels through the portion of the target layer 26 is directed back toward the diffraction grating 25 and interferes with the non-diffracted light due to an optical phase difference between the diffracted and non-diffracted light paths to generate an interference signal. The interference signal contains information about the refractive index of the material of the target layer 26 and information about the thickness of the target layer 26 that are manifested in shifts in the interference fringes. The positioning of the reflector 28 removes the effect of the dielectric layers of the back-end-of-line stack 30 above the target layer 26. The information about the refractive index of the material of the target layer 26 and the information about the thickness of the target layer 26 is coupled in the interference signal. Multiple metrology structures with different angles of diffraction may be used to decouple the information about the refractive index of the material of the target layer 26 from the information about the thickness of the target layer 26.

The metrology structure embodied in the structure 10 enables a complete on-wafer optical measurement of the refractive index of the material of the target layer 26 and the thickness of the target layer 26 that avoids focusing errors inherent to conventional external interferometry and ellipsometry. The metrology structure may be used to measure the refractive index of the material of the target layer 26 and the thickness of the target layer 26 if the target layer 26 is buried in a complex stack, which contrasts with the capabilities of conventional external interferometry and ellipsometry. Parallel measurement of multiple portions of the target layer at different sites may permit spatial correlation of the refractive index of the material of the target layer 26 and spatial correlation of the thickness of the target layer 26. The curve-fitting technique required to extract the refractive index of the material of the target layer 26 and the thickness of the target layer 26 may be simpler than the curve-fitting techniques required by conventional external interferometry and ellipsometry. The target layer 26 may be patterned to construct photonic components and/or waveguide cores connecting photonic components.

In an embodiment, the metrology structure embodied in the structure 10 may be deployed on a product wafer to enable post-situ measurement of the refractive index and the thickness of the target layer 26. In an embodiment, the metrology structure embodied in the structure 10 may be deployed on a test wafer to enable measurement of the refractive index and the thickness of the target layer 26.

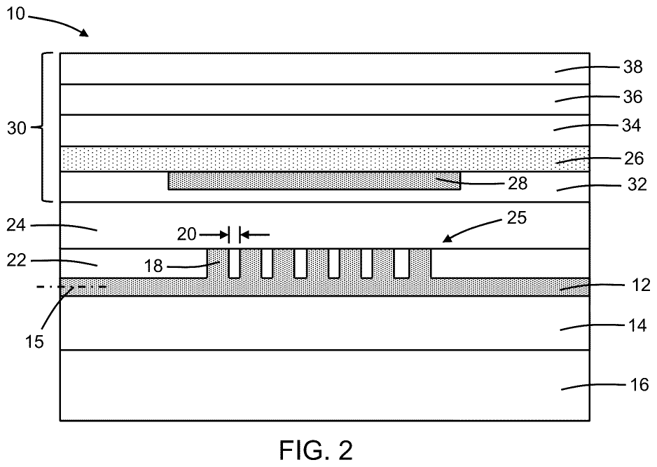

With reference to FIG. 2 and in accordance with alternative embodiments, the stacking of the target layer 26 and the reflector 28 may be inverted relative to the diffraction grating 25 such that the reflector 28 is arranged in a vertical direction between the portion of the target layer 26 under test and the diffraction grating 25 included in the waveguide core 12. The interference signal from this arrangement of the portion of the target layer 26 under test and the reflector 28 in the metrology structure may be used to remove the effect of material, such as the dielectric layer 24 and the dielectric layer 32, arranged between the diffraction grating 25 and the target layer 26.

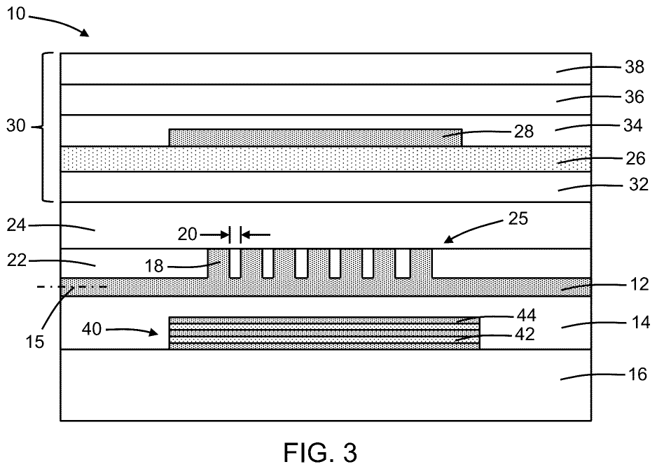

With reference to FIG. 3 and in accordance with alternative embodiments, the structure may further include a Bragg reflector 40 that is arranged beneath the diffraction grating 25. The diffraction grating 25 may overlap with the Bragg reflector 40. The Bragg reflector 40 may include layers 42 and layers 44 that alternate with the layers 42 such that the layers 42 are interleaved with the layers 44 to provide a multilayer stack. The layers 42 may be comprised of a material with different composition from the material of the layers 44 and, due to the compositional difference, the material of the layers 42 and the material of the layers 44 are characterized by different refractive indices. In an embodiment, the material comprising the layers 42 may be characterized by a refractive index, and the material comprising the layers 44 may also be characterized by a refractive index that is greater than the refractive index of the material comprising the layers 42. In an embodiment, the material comprising the layers 42 may be an oxide, and the material comprising the layers 44 may also be an oxide of different composition. In an embodiment, the materials for the layers 42, 44 may be selected from silicon dioxide, aluminum oxide, hafnium oxide, tantalum oxide, or titanium oxide. In an embodiment, the layers 42 may be comprised of silicon oxide (e.g., silicon dioxide), and the layers 44 may be comprised of aluminum oxide, hafnium oxide, titanium oxide, or tantalum oxide.

A portion of the light may be diffracted downwardly by the diffraction grating 25 toward the semiconductor substrate 16 instead of upwardly toward the target layer 26. The underlying Bragg reflector 40 may reflect this otherwise-lost light back toward the diffraction grating 25. The reflected light may improve the efficiency and accuracy of the metrology structure embodied in the structure 10.

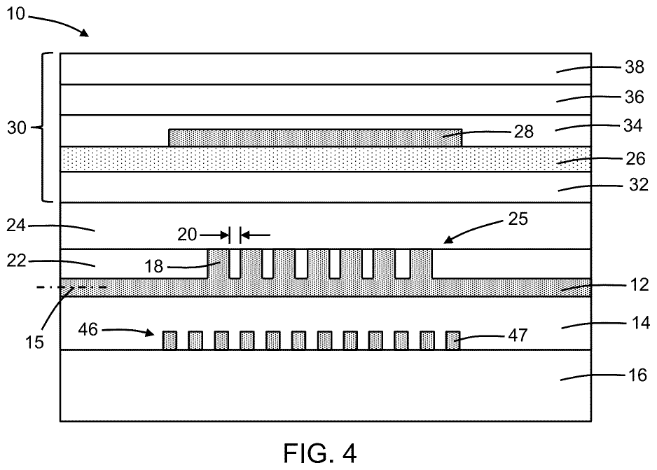

With reference to FIG. 4 and in accordance with alternative embodiments, the structure 10 may include a diffraction grating 46 that is arranged beneath the diffraction grating 25. The diffraction grating 25 may overlap with the diffraction grating 46. The diffraction grating 46 includes segments 47 with a periodicity effective to reflect light diffracted by the diffraction grating 25 in a downward direction toward the semiconductor substrate 16 back toward the diffraction grating 25, which may improve the efficiency and accuracy of the metrology structure embodied in the structure 10.

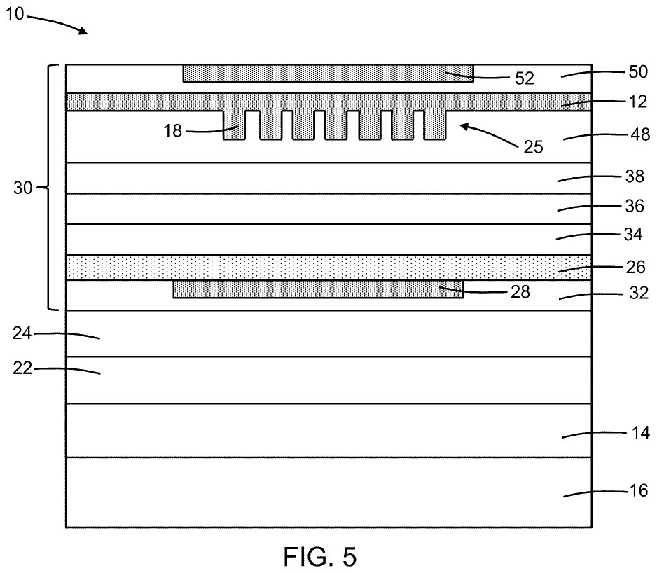

With reference to FIG. 5 and in accordance with alternative embodiments, the back-end-of-line stack 30 may include dielectric layers 48, 50, and the diffraction grating 25 and a reflector 52 may be formed in the dielectric layers 48, 50. The diffraction grating 25 is positioned in a vertical direction between the reflector 52 and the portion of the target layer 26 under test. The portion of the target layer 26 is positioned in a vertical direction between the reflector 28 and the diffraction grating 25 included in the waveguide core 12. The reflector 52, which overlies the diffraction grating 25, is arranged to reflect upwardly-diffracted light back to the diffraction grating 25. The reflector 52 may be a patterned layer that is comprised of a metal, such as copper or aluminum.

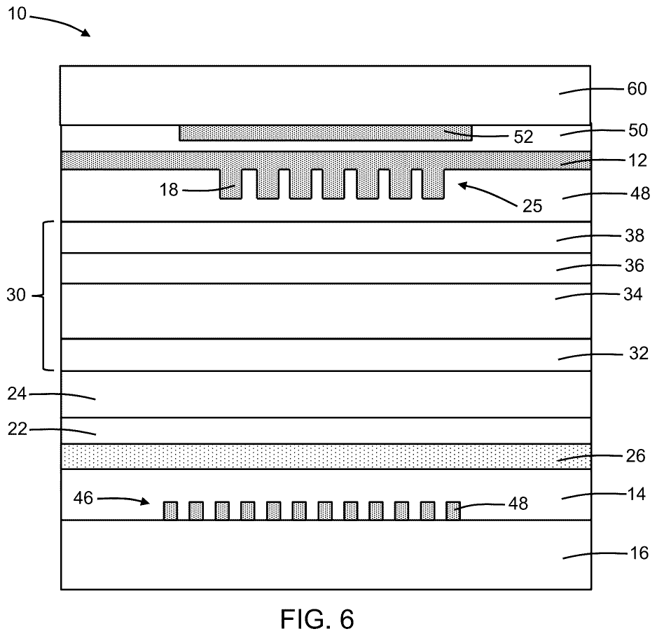

With reference to FIG. 6 and in accordance with alternative embodiments, the diffraction grating 25, the dielectric layers 48, 50, and the reflector 52 may be supported on a semiconductor substrate 60 and added to the structure 10 by a wafer bonding technique instead of being included in the back-end-of-line stack 30. A portion of the target layer 26 under test is arranged in a vertical direction between the diffraction grating 46 and the diffraction grating 25.

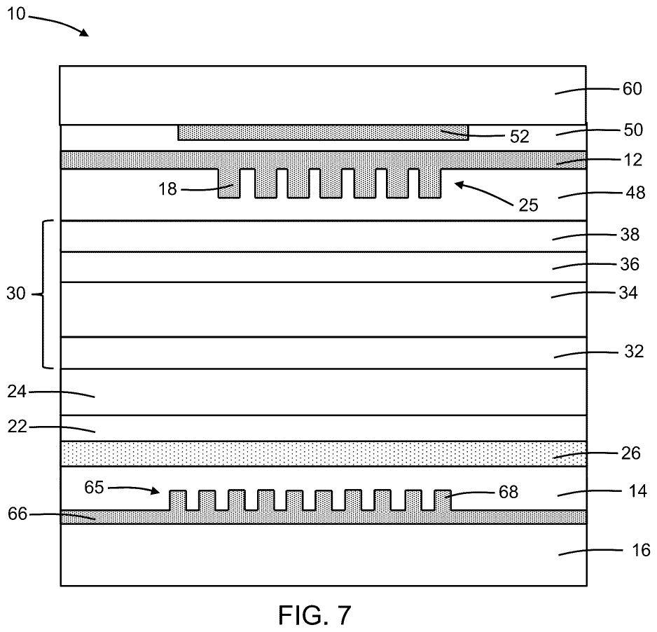

With reference to FIG. 7 and in accordance with alternative embodiments, the diffraction grating 25, the dielectric layers 48, 50, and the reflector 52 may be supported on a semiconductor substrate 60 and added to the structure 10 by a wafer bonding technique instead of being included in the back-end-of-line stack 30. A portion of the target layer 26 under test is arranged in a vertical direction between the diffraction grating 25 and a diffraction grating 65 included in a waveguide core 66. The diffraction grating 65 has multiple grating lines or grating segments 68 arranged with a spaced arrangement along a longitudinal axis of the waveguide core 66. The diffraction grating 65 is characterized by parameters, such as the period of the grating segments 68, that determine the outbound angle of diffraction for light that is diffracted by the diffraction grating 65. In an embodiment, the pitch and duty cycle of the grating segments 68 may be uniform to define a periodic arrangement. In alternative embodiments, the pitch and/or the duty cycle of the grating segments 68 may be apodized (i.e., non-uniform) to define a non-periodic arrangement. The diffraction grating 65 may alternatively be utilized as a second source of light for determining the refractive index of the material of the portion of the target layer 26 under test and the thickness of the portion of the target layer 26 under test.

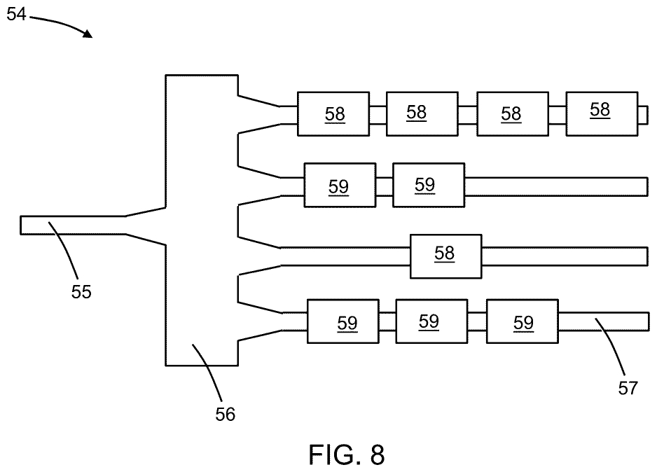

With reference to FIG. 8 and in accordance with alternative embodiments, a structure 54 may include a multimode interference splitter 56, an input waveguide core 55 coupled to an input port of the multimode interference splitter 56, and multiple waveguide cores 57 coupled to output ports of the multimode interference splitter 56. Although not shown, the target layer 26 is positioned over the structure 54. Arranged along each of the waveguide cores 57 are one or more instances of a metrology structure 58, 59 embodied in the structure 10. For example, instances of the metrology structure 58 embodied in the structure 10 of FIG. 1 with the target layer 26 arranged between the multimode interference splitter 56 and the reflector 28 may be included in a pair of the waveguide cores 57, and instances of the metrology structure 59 embodied in the structure 10 of FIG. 2 with the reflector 28 arranged between the multimode interference splitter 56 and the target layer 26 may be included in a pair of the waveguide cores 57. In an alternative embodiment, mixed instances one or more of metrology structures 58, 59 may be included in one or more of the waveguide cores 57.

The different instances of the metrology structure may be used to measure the refractive index of the material of portions of the target layer 26 and the thickness of portions of the target layer 26 at multiple different spatial locations. The different instances of the metrology structure may be characterized by diffraction gratings 25 with different angles of diffraction, which may be useful in decoupling the information about the refractive index of the material of the portions of the target layer 26 from the information about the thickness of the portions of the target layer 26.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. A feature may “overlie” another feature if the feature is positioned in elevation over another feature. Different features may “overlap” if a feature extends over, and covers all or a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A metrology structure comprising:
a target layer;
a first waveguide core including a first diffraction grating; and
a first reflector,
wherein the target layer includes a first portion that is arranged between the first diffraction grating and the first reflector or the first reflector is arranged between the first diffraction grating and the first portion of the target layer.

2. The metrology structure of claim 1 wherein the target layer is arranged between the first diffraction grating and the first reflector.

3. The metrology structure of claim 1 wherein the first reflector is arranged between the first diffraction grating and the target layer.

4. The metrology structure of claim 1 further comprising:
a semiconductor substrate; and
a Bragg reflector,
wherein the first diffraction grating is arranged between the semiconductor substrate and the target layer.

5. The metrology structure of claim 4 wherein the target layer is arranged between the first diffraction grating and the first reflector.

6. The metrology structure of claim 4 wherein the first reflector is arranged between the first diffraction grating and the target layer.

7. The metrology structure of claim 1 further comprising:
a semiconductor substrate; and
a second diffraction grating,
wherein the second diffraction grating is arranged between the semiconductor substrate and the first diffraction grating.

8. The metrology structure of claim 1 further comprising:
a semiconductor substrate,
wherein the first diffraction grating is arranged between the first portion of the target layer and the semiconductor substrate.

9. The metrology structure of claim 1 further comprising:
a second waveguide core including a second diffraction grating; and
a second reflector,
wherein the target layer includes a second portion arranged between the second diffraction grating and the second reflector or the second reflector is arranged between the second diffraction grating and the second portion of the target layer.

10. The metrology structure of claim 9 wherein the first diffraction grating includes a first plurality of grating segments arranged with a first periodicity, and the second diffraction grating includes a second plurality of grating segments arranged with a second periodicity.

11. The metrology structure of claim 10 further comprising:
a multimode interference splitter having a first output port and a second output port,
wherein the first waveguide core is coupled to the first output port, and the second waveguide core is coupled to the second output port.

12. The metrology structure of claim 1 further comprising:
a semiconductor substrate; and
a back-end-of-line stack overlying the semiconductor substrate,
wherein the target layer and the first reflector are positioned in the back-end-of-line stack.

13. The metrology structure of claim 12 wherein the first diffraction grating is positioned in the back-end-of-line stack.

14. The metrology structure of claim 13 wherein the first portion of the target layer is arranged between the first diffraction grating and the first reflector.

15. The metrology structure of claim 14 further comprising:
a second reflector in the back-end-of-line stack,
wherein the first diffraction grating is positioned between the second reflector and the first portion of the target layer.

16. The metrology structure of claim 12 wherein the back-end-of-line stack includes a plurality of dielectric layers positioned between the first portion of the target layer and the first diffraction grating.

17. The metrology structure of claim 12 further comprising:
a second diffraction grating,
wherein the first portion of the target layer is positioned between the first diffraction grating and the second diffraction grating.

18. The metrology structure of claim 10 wherein the first portion of the target layer is arranged between the first diffraction grating and the first reflector.

19. The metrology structure of claim 12 further comprising:
a second reflector,
wherein the first diffraction grating is positioned between the second reflector and the first portion of the target layer.

20. A method of forming a metrology structure, the method comprising:
forming a waveguide core including a diffraction grating;
forming a target layer; and
forming a reflector,
wherein the target layer includes a portion that is arranged between the diffraction grating and the reflector or the reflector is arranged between the diffraction grating and the portion of the target layer.
